(19) United States
(12) Patent Application Publication
(10) Pub. No.: US 2021/0394135 A1
(43) Pub. Date: Dec. 23, 2021

(54) PROPELLER FOR A DIGESTION TANK MIXER

(71) Applicant: Xylem Europe GmbH, Schaffhausen (CH)

(72) Inventor: Peter Loman, Järfälla (SE)

(73) Assignee: Xylem Europe GmbH, Schaffhausen (CH)

(21) Appl. No.: 17/284,038

(22) PCT Filed: Oct. 4, 2019
(86) PCT No.: PCT/EP2019/076861

§ 371 Date: Apr. 9, 2021

(30) Foreign Application Priority Data
Oct. 12, 2018 (EP) 18200116.4

(51) Int. Cl. B01F 7/00; C02F 3/28

(52) U.S. Cl. CPC B01F 7/00375; C02F 3/2866; B01F 7/00033; B01F 2215/0052; B01F 2215/0422; B01F 2215/0427; B01F 2215/0431; C02F 2203/006

(57) ABSTRACT

A propeller for a digestion tank mixer. The propeller has a hub and at least two blades. Each blade has an outer geometrical plane parallel to a center axis, perpendicular to a radius of the propeller, intersecting both a leading edge and a trailing edge of the blade, and an inner geometrical plane parallel to the outer geometrical plane and tangent to the hub. Each intermediate geometrical plane of the blade has an arc-shaped cross section extending between the leading edge and the trailing edge, and a chord extending between the leading edge and the trailing edge. An angle between the chord and a radial plane of the propeller is 25-45 degrees in each intermediate geometrical plane. The ratio between an arc-height between the chord and the thrust side surface, and the length of the chord, is 0.08-0.15 in each intermediate geometrical plane.

### TECHNICAL FIELD OF THE INVENTION

The present invention relates generally to the field of mixers for mixing liquid comprising solid matter, such as sewage, biomass slurry, etc. The present matter relates to a mixer for wastewater treatment applications. Further, the present invention relates specifically to the field of mixers for digestion tanks, i.e. biogas applications. These mixers belong to the field of submersible geared mixers, i.e. mixers having slowly rotating propellers (50-150 rpm) wherein the mixer is arranged to be partly or wholly lowered into the liquid/slurry.

The present invention relates to a propeller for such a mixer, wherein the propeller comprises a hub and at least two blades. The single blade comprises a thrust side surface, a suction side surface, an inner edge fixedly connected to the hub, an outer edge located at a distance from the hub, a leading edge extending from the inner edge to the outer edge and a trailing edge extending from the inner edge to the outer edge, wherein for each blade there is an outer geometrical plane that is parallel to a center axis of the propeller, perpendicular to a radius of the propeller and intersects both the leading edge and the trailing edge, and comprises at least one of the intersection between the outer edge and the leading edge and the intersection between the outer edge and the trailing edge, there is an inner geometrical plane that is parallel to the outer geometrical plane and that is tangent to the hub, and there is a radial distance between and perpendicular to the outer geometrical plane and the inner geometrical plane. The present invention also relates to a mixer for a digestion tank.

### BACKGROUND OF THE INVENTION

Usually digestion tank mixers comprise propellers made of plastic. The viscous nature of the biomass slurry in biogas applications requires that the mixer, i.e. propeller, delivers elevated thrust in order to generate a proper mixing and generate a suitable bulk flow in the digestion tank. One straight forward way to increase the thrust is to increase the operational speed of the mixer and/or to increase the size/diameter of the propeller. Thus, it would be advantageous to have a large diameter of the propeller, however the diameter of the propeller is limited by the size of the tank opening used to introduce the mixer into the tank. Thereto, the biogas applications present an extremely abrasive environment for the propeller of the mixer, i.e. very though wear conditions, an increased operational speed will accelerate the wear of the propeller, and an increased diameter of the propeller will increase the power consumption to unacceptable levels. Already at moderate operational speed and limited diameter of the propeller, the propeller of the mixer is subject to considerable wear and needs to be exchanged at regular intervals, sometimes as often as twice or more per year.

The most common design of propeller for digestion tank mixers uses flat and long blades that are tilted approx 45 degrees and extends in a radial direction from the propeller hub, in order to meet the thrust requirements at low operational speed.

### OBJECT OF THE INVENTION

The present invention aims at obviating the aforementioned disadvantages and failings of previously known propellers, and at providing an improved propeller for digestion tank mixer. A primary object of the present invention is to provide an improved propeller of the initially defined type wherein high enough thrust is generated using a limited diameter propeller and without having elevated power consumption.

### SUMMARY OF THE INVENTION

According to the invention at least the primary object is attained by means of the initially defined propeller having the features defined in the independent claim. Preferred embodiments of the present invention are further defined in the dependent claims.

According to the present invention, there is provided a propeller of the initially defined type, which is characterized in that at each intermediate geometrical plane located between and parallel to the outer geometrical plane and the inner geometrical plane, the blade has an arc-shaped cross section that extends between the leading edge and the trailing edge and that is concave on the thrust side, and a chord that extends between the leading edge and the trailing edge, wherein an angle between the chord and a radial plane of the propeller, is equal to or greater than 25 degrees and equal to or less than 45 degrees in each intermediate geometrical plane taken along the entire radial distance, and wherein the ratio between an arc-height (AH) between the chord and the thrust side surface and the length of the chord (C), AH:C, is equal to or greater than 0.08 and equal to or less than 0.15 in each intermediate geometrical plane taken along the entire radial distance. According to the present invention, there is also provided a mixer comprising such a propeller.

Thus, the present invention is based on the insight of the inventors that in order to compensate for decreased diameter of the propeller it is only possible to reach the required thrust levels at a low operational speed by having arc-shaped blades provided with an optimal combination of the angle of the chord and the arc-height-chord ratio along/over the entire radial extension of the blades.

According to a preferred embodiment of the present invention, the arc-height is equal to or greater than 30 millimeters and equal to or less than 70 millimeters in each intermediate geometrical plane taken along the entire radial distance. This means that the concave shape of the blades is considerable and distinct along/over the entire radial extension of the blades.

According to a preferred embodiment of the present invention, the angle between the chord and the radial plane of the propeller is equal to or greater than 29 degrees and equal to or less than 45 degrees in each intermediate geometrical plane taken along the entire radial distance. This means that the pitch of the blades is considerable and distinct along/over the entire radial extension of the blades.

According to a preferred embodiment of the present invention, the length of the chord is equal to or greater than 280 millimeters and equal to or less than 475 millimeters in each intermediate geometrical plane taken along the entire radial distance. This means that the extension of the blades in the circumferential direction is considerable and distinct along/over the entire radial extension of the blades.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a side view of an inventive propeller connected to a digestion tank mixer, seen in the radial direction,

FIG. 2 is a side view of the inventive propeller seen from the thrust side, i.e. seen from above in FIG. 1,

FIG. 3 is a side view of the inventive propeller disclosing the cross section of the blade at the inner geometrical plane,

FIG. 4 is a side view of the propeller disclosing the cross section of the blade at the outer geometrical plane, and

FIG. 5 is a side view of the propeller disclosing the cross section of the blade at one random intermediate geometrical plane.

### DETAILED DESCRIPTION OF PREFERRED EMBODIMENTS OF THE INVENTION

The present invention relates generally to the field of mixers for mixing liquid comprising solid matter, such as sewage, biomass slurry, etc. Thus, in general terms a wastewater/sewage treatment mixer, and especially a digestion tank mixer or biogas mixer.

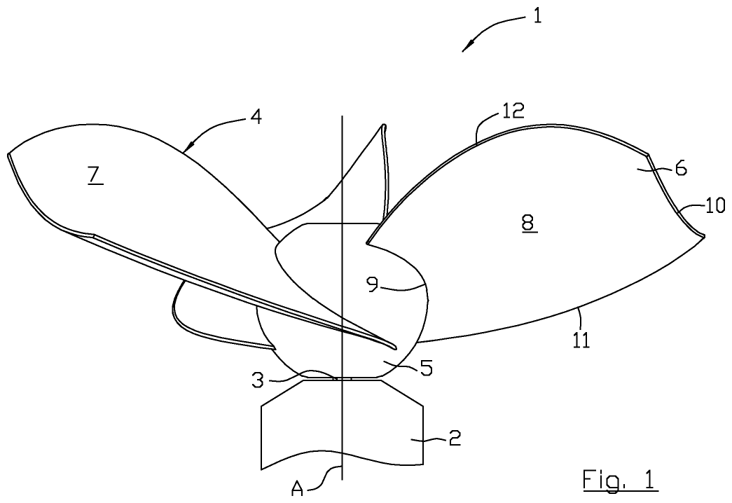

Reference is initially made to FIG. 1, disclosing a forward part of a mixer 1 configured to be used in a digestion tank. The components of the mixer 1 are usually cold down by means of the liquid/water surrounding the mixer 1. Thus the mixer 1 is designed and configured to be able to operate in a submerged configuration/position, i.e. during operation be located entirely under the liquid surface. However, it shall be realized that the submersible mixer 1 during operation must not be entirely located under the liquid surface but may continuously or occasionally be partly located above the liquid surface.

The mixer 1 comprises a liquid tight mixer housing/body 2 housing an electric motor and a transmission, a propeller shaft 3 extending from the transmission and a propeller, generally designated 4, detachably connected to a forward end of the propeller shaft 3. The propeller shaft 3 is also known as drive shaft. Thus, the propeller 4 is driven in rotation by the electric motor via the transmission and the propeller shaft 3. During operation of the mixer 1 the propeller 4 is slowly rotating, i.e. the operational speed of the mixer is preferably in the range 50-150 rpm. The propeller 4 and the propeller shaft 3 have a common center axis A. The electric motor is powered via an electric power cable extending from a power supply, and the mixer 1 comprises a liquid tight lead-through receiving the electric power cable.

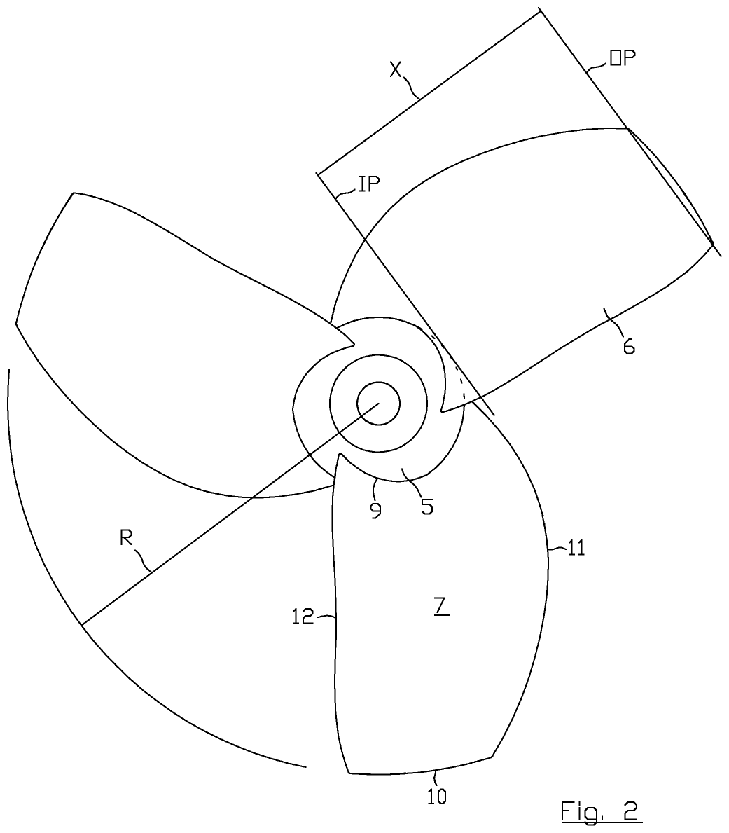

Reference is now also made to FIG. 2. The propeller 4 comprises a hub 5 and at least two blades 6. The hub 5 has preferably a spherical primary shape, at least in the region where the blades 6 are attached to the hub 5. The blades 6 are pre-shaped and then attached/welded to the hub 5. The propeller 4 is made of metal, preferably stainless steel, and each blade 6 is made of metal sheet, i.e. having uniform thickness over the entire extension of the blade 6. In the preferred embodiment disclosed in the figures the propeller 4 comprises three blades 6, and as disclosed in FIG. 2 the blades 6 preferably overlap each other in the proximal region, seen in the axial direction. The hub 5 is preferably hollow, i.e. having an outer shell and an inner structure configured to cooperate with the propeller shaft 3.

Each blade 6 comprises a thrust side surface 7 and a suction side surface 8. Thereto the blade 6 comprises an inner edge 9 fixedly connected to the hub 5 and an outer edge 10 located at a distance from the hub 5, i.e. at least a part of the outer edge 10 is located at an outer diameter/periphery of the propeller 4, a leading edge 11 extending from the inner edge 9 (hub 5) to the outer edge 10, and a trailing edge 12 extending from the inner edge 9 (hub 5) to the outer edge 10. Thus, during operation the propeller 4 will rotate in the counter clockwise direction in FIG. 2 and the liquid slurry will flow in the upwards direction in FIG. 1. The inventive shape of the propeller 4 blades 6 will redirect and accelerate the liquid slurry. Preferably the entire outer edge 10 is located at the outer diameter of the propeller 4. At least one of the intersections between the outer edge 10 and the leading edge 11 and the trailing edge 12, respectively, is located at the outer diameter/periphery of the propeller 4. Said intersections are preferably rounded. According to the disclosed embodiment the outer diameter of the propeller 4 is equal to or less than 1350 millimeters, preferably equal to or less than 1300 millimeters, and most preferably equal to or less than 1250 millimeters. Preferably, the inner edge 9 is S-shaped.

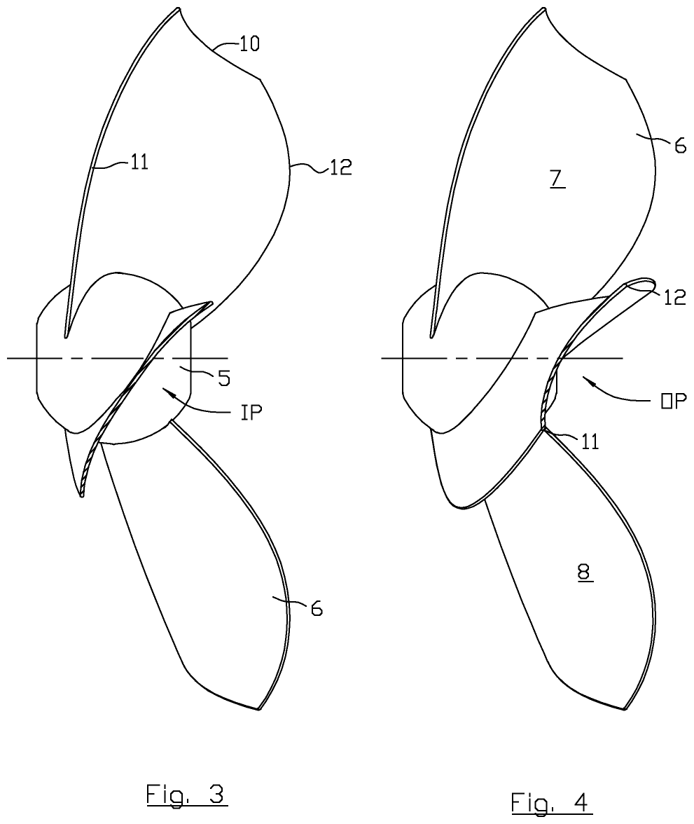

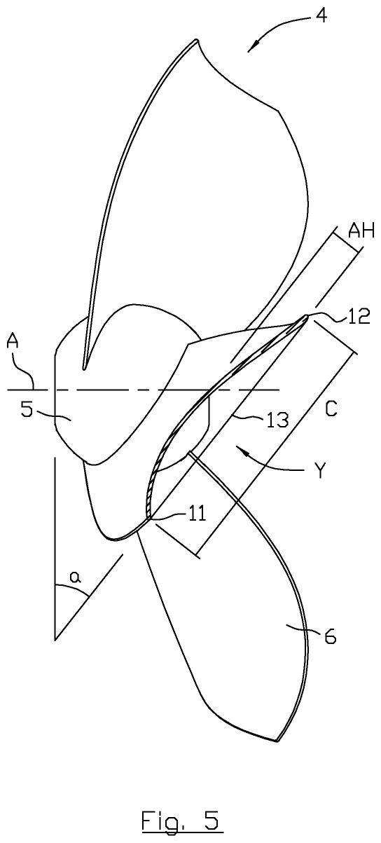

Reference is now also made to FIGS. 3 and 4. For each blade 6 there is an outer geometrical plane OP (cross section) disclosed in FIGS. 2 and 4, and an inner geometrical plane IP (cross section) disclosed in FIGS. 2 and 3.

The outer geometrical plane OP is parallel to the center axis A of the propeller 4, and is perpendicular to a radius R of the propeller 4 and intersects both the leading edge 11 and the trailing edge 12 of the blade 6. The radius R of the propeller 4 originates from the center axis A of the propeller 4. Further, the outer geometrical plane OP comprises/includes at least one of the intersection between the outer edge 10 and the leading edge 11 and the intersection between the outer edge 10 and the trailing edge 12. Preferably the outer geometrical plane OP comprises/includes both intersections between the outer edge 10 and the leading edge 11 and the trailing edge 12, respectively.

The inner geometrical plane IP is parallel to the outer geometrical plane OP, and is tangent to the hub 5. There is a radial distance X between the outer geometrical plane OP and the inner geometrical plane IP, taken perpendicular to the outer geometrical plane OP and to the inner geometrical plane IP. The inner edge 9 of the blade 6 is entirely located inwards the inner geometrical plane IP seen in the radial direction, i.e. closer to the center line A of the propeller 4.

Reference is now also made to FIG. 5. The outer geometrical plane OP and the inner geometrical plane IP as well as each intermediate geometrical plane Y located between and parallel to the outer geometrical plane OP and the inner geometrical plane IP has an arc-shaped cross section that extends between the leading edge 11 and the trailing edge 12 and that is concave on the thrust side, and has a geometrical chord 13 that extends between the leading edge 11 and the trailing edge 12.

It is essential for the invention that an angle a between the chord 13 and a radial plane of the propeller 4 is equal to or greater than 25 degrees and equal to or less than 45 degrees in each intermediate geometrical plane Y taken along the entire radial distance X, at the same time as the ratio between an arc-height AH between the chord 13 and the thrust side surface 7 and the length of the chord C, i.e. AH:C, is equal to or greater than 0.08 and equal to or less than 0.15 in each intermediate geometrical plane Y taken along the entire radial distance X. This combination of angle a and ratio AH:C is optimal in order not to exceed the predetermined power levels and at the same time reach the required thrust levels.

It shall be pointed out that the chord 13 is provided by using a ruler or the like abutting both the trailing edge 12 and the leading edge 11. The length of the chord C is equal to the distance between the two abutment points, and the arc-height AH is the greatest distance between the chord 13, i.e. the ruler, and the thrust side surface 7, measured perpendicular to the chord 13.

According to a preferred embodiment, the ratio AH:C is equal to or greater than 0.10 in each intermediate geometrical plane Y taken along at least a continuous range of 80% of the entire radial distance X. According to a preferred embodiment, the ratio AH:C is equal to or greater than 0.12 in each intermediate geometrical plane Y taken along at least a continuous range of 60% of the entire radial distance X. Preferably, said ranges does not include the inner geometrical plane IP. Preferably, said ranges include the outer geometrical plane OP.

The arc-height AH is equal to or greater than 30 millimeters and equal to or less than 70 millimeters in each intermediate geometrical plane Y taken along the entire radial distance X. Preferably the arc-height AH is equal to or greater than 35 millimeters and equal to or less than 65 millimeters in each intermediate geometrical plane Y taken along the entire radial distance X. The resulting combination of arc-height AH and ratio AH:C is optimal in order not to exceed the predetermined power levels and at the same time reach the required thrust levels.

According to a preferred embodiment, the arc-height AH is equal to or greater than 45 millimeters and equal to or less than 70 millimeters in each intermediate geometrical plane Y taken along at least a continuous range of 70% of the entire radial distance X, wherein said range does not include at least the inner geometrical plane IP and the outer geometrical plane OP. Preferably, said range is centered between the inner geometrical plane IP and the outer geometrical plane OP.

According to a preferred embodiment, the angle a between the chord 13 and the radial plane of the propeller 4 is equal to or greater than 29 degrees and equal to or less than 45 degrees in each intermediate geometrical plane Y taken along the entire radial distance X. Preferably the angle a is equal to or less than 40 degrees in each intermediate geometrical plane Y taken along the entire radial distance X.

According to a preferred embodiment, the angle a between the chord 13 and the radial plane of the propeller 4 is equal to or greater than 35 degrees and equal to or less than 45 degrees in each intermediate geometrical plane Y taken along at least a continuous range of 70% of the entire radial distance X, wherein said range does not include at least the inner geometrical plane IP and the outer geometrical plane OP. Preferably the angle a is equal to or less than 40 degrees in each intermediate geometrical plane Y taken along at least a continuous range of 70% of the entire radial distance X, wherein said range does not include at least the inner geometrical plane IP and the outer geometrical plane OP. Preferably, said range is centered between the inner geometrical plane IP and the outer geometrical plane OP.

Preferably the angle a between the chord 13 and the radial plane of the propeller 4 is equal to or greater than 30 degrees and equal to or less than 45 degrees in each geometrical plane Y taken along at least a continuous range of 95% of the entire radial distance X, said range including the inner geometrical plane IP.

The length of the chord C is equal to or greater than 280 millimeters and equal to or less than 475 millimeters in each intermediate geometrical plane Y taken along the entire radial distance X. The resulting combination of chord length C and ratio AH:C is optimal in order not to exceed the predetermined power levels and at the same time reach the required thrust levels.

Preferably, the length of the chord C is equal to or greater than 380 millimeters and equal to or less than 475 millimeters in each intermediate geometrical plane Y taken along at least a continuous range of 70% of the entire radial distance X, wherein said range does not include at least the inner geometrical plane IP and the outer geometrical plane OP. Preferably, said range is centered between the inner geometrical plane IP and the outer geometrical plane OP.

A maximum projected distance in the axial direction of the propeller 4 between two points on the leading edge 11 is equal to or greater than 180 millimeters, preferably equal to or greater than 190 millimeters. Thereto, said distance is less than 210 millimeters. A maximum projected distance in the axial direction of the propeller 4 between two points on the trailing edge 12 is equal to or greater than 190 millimeters, preferably equal to or greater than 200 millimeters. Thereto, said distance is less than 220 millimeters. The maximum projected distance in the axial direction of the propeller is equal to a vertical distance measured in a side view according to FIG. 1.

A distance in the axial direction of the propeller 4 between a radial plane comprising the intersection between the inner edge 9 and the trailing edge 12 and a radial plane comprising the intersection between the outer edge 10 and the trailing edge 12 is greater than 145 millimeters, preferably greater than 150 millimeters. Thereto, said distance is less than 160 millimeters. The distance in the axial direction of the propeller is equal to a vertical distance measured in a side view according to FIG. 1.

The blades 6 of the propeller 4 are at least partly double curved, i.e. having positions wherein the propeller 6 is curved along two mutually intersecting directions, as can be seen in FIG. 4.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1.-14. (canceled)

15. A propeller for a digestion tank mixer, the propeller comprising a hub and at least two blades, each blade comprising:
a thrust side surface and a suction side surface;
an inner edge fixedly connected to the hub and an outer edge located at a distance from the hub;
a leading edge extending from the inner edge to the outer edge and a trailing edge extending from the inner edge to the outer edge;
an outer geometrical plane parallel to a center axis of the propeller, perpendicular to a radius of the propeller, and intersecting both the leading edge and the trailing edge, the outer geometric plane comprising at least one of: (a) a leading intersection between the outer edge and the leading edge, and (b) a trailing intersection between the outer edge and the trailing edge;
an inner geometrical plane parallel to the outer geometrical plane and tangent to the hub;
a radial distance between and perpendicular to the outer geometrical plane and the inner geometrical plane;
an arc-shaped cross section extending between the leading edge and the trailing edge and that is concave on the thrust side; and
a plurality of intermediate geometrical planes located between and parallel to the outer geometrical plane and the inner geometrical plane along an entirety of the radial distance, each intermediate geometrical plane comprising:
a chord having a length that extends between the leading edge and the trailing edge;
an angle of 25-45 degrees between the chord and a radial plane of the propeller;
an arc-height between the chord and the thrust side surface;
a ratio of 0.08-0.15 between the arc-height and the length of the chord in each intermediate geometrical plane along the entire radial distance.

16. The propeller of claim 1, wherein the arc-height is in a range of 30-70 millimeters in each intermediate geometrical plane along the entirety of the radial distance.

17. The propeller of claim 1, wherein the arc-height is in a range of 45-70 millimeters in a subset of the plurality of intermediate geometrical planes extending along a continuous range of at least 70% of the entirety of the radial distance, the continuous range excluding at least the inner geometrical plane and the outer geometrical plane.

18. The propeller of claim 1, wherein the angle between the chord and the radial plane of the propeller is in a range of 29-45 degrees in each intermediate geometrical plane along the entirety of the radial distance.

19. The propeller of claim 1, wherein the angle between the chord and the radial plane of the propeller is in a range of 35-45 degrees in a subset of the plurality of intermediate geometrical planes extending along a continuous range of at least 70% of the entirety of the radial distance, the continuous range excluding at least the inner geometrical plane and the outer geometrical plane.

20. The propeller of claim 1, wherein the angle between the chord and the radial plane of the propeller is in a range of 30-45 degrees in at least two of a subset of the plurality of intermediate geometrical planes, the inner geometrical plane, and the outer geometrical plane, along at least a continuous range of 95% of the entirety of the radial distance, the continuous range including the inner geometrical plane.

21. The propeller of claim 1, wherein the length of the chord is in a range of 280-475 millimeters in each intermediate geometrical plane along the entirety of the radial distance.

22. The propeller of claim 1, wherein the length of the chord is in a range of 380-475 millimeters in each intermediate geometrical plane along a continuous range of at least 70% of the entirety of the radial distance, the continuous range excluding at least the inner geometrical plane and the outer geometrical plane.

23. The propeller of claim 1, wherein a leading maximum projected distance in an axial direction of the propeller between two points on the leading edge is equal to or greater than 180 millimeters.

24. The propeller of claim 1, wherein a trailing maximum projected distance in an axial direction of the propeller between two points on the trailing edge is equal to or greater than 190 millimeters.

25. The propeller of claim 1, wherein a diagonal distance in an axial direction of the propeller between a trailing radial plane comprising the intersection between the inner edge and the trailing edge and a leading radial plane comprising the intersection between the outer edge and the trailing edge is greater than 145 millimeters.

26. The propeller of claim 1, wherein the blades and the hub comprise metal.

27. The propeller of claim 26, wherein the metal comprises stainless steel.

28. The propeller of claim 1, wherein the outer diameter of the propeller is equal to or less than 1350 millimeters.

29. A mixer for a digestion tank, the mixer comprising:
a mixer body;
a propeller shaft; and
the propeller of claim 1 connected to the propeller shaft.
